(19) United States
(12) Patent Application Publication
(10) Pub. No.: US 2025/0231760 A1
(43) Pub. Date: Jul. 17, 2025

(54) METHOD AND DEVICE FOR UPDATING BOOT SOFTWARE

(71) Applicant: HYUNDAI AUTOEVER CORP., Seoul (KR)

(72) Inventor: Byung Woo KIM, Seoul (KR)

(73) Assignee: HYUNDAI AUTOEVER CORP., Seoul (KR)

(21) Appl. No.: 18/987,187

(22) Filed: Dec. 19, 2024

(30) Foreign Application Priority Data
Jan. 12, 2024 (KR) 10-2024-0005140

(51) Int. Cl. G06F 8/65; G06F 9/4401

(52) U.S. Cl. CPC G06F 8/65; G06F 9/4401

(57) ABSTRACT

A method for updating boot software, which is performed by a computing device, includes storing a new boot to a buffer area, in response to success of the storing the new boot to a buffer area, removing an existing boot of an update target host, copying the new boot to the boot area of the update target host, and deleting the new boot stored in the buffer area.

### CROSS-REFERENCE TO RELATED APPLICATION

This application claims the benefit of and priority to Korean Patent Application No. 10-2024-0005140 filed on Jan. 12, 2024 in the Korean Intellectual Property Office, the entire contents of which are incorporated herein by reference.

### TECHNICAL FIELD

The present disclosure relates to a method for updating a boot software of a vehicle and a device for performing the method. More particularly, the present disclosure relates to a method for preventing false detection when an unexpected situation occurs during a boot software update process of a vehicle and a device for performing the method.

### BACKGROUND

Recently, various electronic devices are being included in vehicles for the convenience of users. In particular, because the functions, such as autonomous driving functions and communication functions with other vehicles, are being applied to vehicles, the electronic devices included in vehicles are becoming more diverse. In order to control these numerous electronic devices, the vehicle also includes a plurality of vehicle controllers, and individual functions of the vehicle are performed via communication between various components included in the vehicle.

As the vehicle structure becomes more complex, various information is transmitted and received through communication between various components included in the vehicle. Because such various information is transmitted and received to and from the components, it is necessary to prevent external intrusions for malicious manipulation of the information. Although update of software to which a security module that prevents the external intrusion has been applied is generally not frequently required, the update of software often occurs due to the discovery of bugs.

However, an existing security module had the problem of not being able to flexibly cope with an unexpected situation that may occur not under the external intrusion but during the update. When the security module with the strongest reaction is not able to flexibly cope with the unexpected situation, the electronic device of the vehicle cannot be booted, and a part with the security module function applied to the vehicle cannot be used permanently. Therefore, the security module with the strongest reaction may actually become a vulnerability. The subject matter described in this background section is intended to promote an understanding of the background of the disclosure and thus may include subject matter that is not already known to those of ordinary skill in the art.

### SUMMARY

A technical purpose to be achieved according to the present disclosure is to provide a method for smoothly performing re-update even when an unexpected situation occurs during an update, and a device for performing the method is also provided.

A technical purpose to be achieved according to an embodiment of the present disclosure is to provide a method for performing an update that is robust to an unexpected situation occurring during an update, and a device for performing the method is also provided.

The technical purposes of the present disclosure are not limited to the technical purposes as mentioned above, and other technical purposes as not mentioned may be clearly understood by those having ordinary skill in the art from descriptions as set forth below.

According to an aspect of the present disclosure, a method for updating boot software, which is performed by a computing device, includes storing a new boot to a buffer area, in response to success of the storing the new boot; removing an existing boot of an update target host; copying the new boot to the boot area of the update target host; and deleting the new boot stored in the buffer area.

In an embodiment, the method further includes generating a reference checksum using a boot of a boot checksum check target; and when a boot checksum stored in a non-volatile memory of a secure boot module is different from the reference checksum, stopping a booting using a boot of the update target host.

In an embodiment, generating the reference checksum may include obtaining the boot checksum check target from secure boot module configuration data stored in the non-volatile memory of the secure boot module.

In an embodiment removing the existing boot of the update target host in response to the success of the storing the new boot may include generating a boot checksum of the new boot using the new boot in response to the success of downloading; updating a boot checksum stored in the non-volatile memory of the secure boot module; setting the boot checksum check target to the buffer area; and after completion of the setting, removing the existing boot of the update target host.

In an embodiment, the new boot may include a predefined marker pattern in a pre-specified offset. Stopping the booting using the boot of the update target host when the boot checksum stored in the non-volatile memory of the secure boot module is different from the reference checksum includes performing a previous update success determination process when the boot checksum stored in the non-volatile memory of the secure boot module is identical with the reference checksum, The previous update success determination process includes identifying presence or absence of the predefined marker pattern in the pre-specified offset of the buffer area; determining presence or absence of the new boot stored in the buffer area, based on an identifying result; and upon determination that the new boot stored in the buffer area is present, retrying an update process using the new boot stored in the buffer area.

In an embodiment, copying the new boot to the boot area of the update target host may include storing a boot update flag.

In an embodiment, the method may further include, after the deleting of the new boot stored in the buffer area, setting a boot checksum check target to the boot area of the update target host.

In an embodiment, setting the boot checksum check target to the boot area of the update target host further may include deleting a boot update flag.

According to an aspect of the present disclosure, a computing system having a boot software update function includes a host including a boot area in which an existing boot is stored and includes a secure boot module including a random access memory (RAM). The secure boot module is configured to: store a new boot for the host to a buffer area formed in the RAM; remove an existing boot of the host from the boot area of the host in response to success of the storing the new boot; copy the new boot stored in the buffer area to the boot area of the host; and delete the new boot stored in the buffer area.

In an embodiment, the secure boot module may generate a reference checksum using a boot of a boot checksum check target; and may stop a booting using a boot of an update target host when a boot checksum stored in a non-volatile memory of the secure boot module and the reference checksum are different from each other.

In an embodiment, when generating the reference checksum, the secure boot module may obtain the boot checksum check target from secure boot module configuration data stored in the non-volatile memory of the secure boot module.

In an embodiment, when removing the existing boot of the update target host in response to the success of the storing the new boot, the secure boot module may generate a boot checksum of the new boot using the new boot in response to the success of the storing the new boot; may update a boot checksum stored in the non-volatile memory of the secure boot module; may set the boot checksum check target to the buffer; and may remove the existing boot of the update target host after completion of the setting.

In an embodiment, the new boot may include a predefined marker pattern in a pre-specified offset. When stopping the booting using the boot of the update target host when the boot checksum stored in the non-volatile memory of the secure boot module is different from the reference checksum, the secure boot module may perform a previous update success determination process when the boot checksum stored in the non-volatile memory of the secure boot module is identical with the reference checksum. When performing the previous update success determination process, the secure boot module may identify presence or absence of the predefined marker pattern in the pre-specified offset of the buffer area; may determine presence or absence of the new boot stored in the buffer area, based on an identifying result; and upon determination that the new boot stored in the buffer area is present, may retry an update process using the new boot stored in the buffer area.

In an embodiment, when copying the new boot to the boot area of an update target host, the secure boot module may store a boot update flag.

In an embodiment, the secure boot module further may further set a boot checksum check target to the boot area of an update target host after deleting the new boot stored in the buffer area.

In an embodiment, when setting the boot checksum check target to the boot area of the update target host, the secure boot module may delete a boot update flag.

### BRIEF DESCRIPTION OF DRAWINGS

The above and other aspects and features of the present disclosure should become more apparent by describing in detail illustrative embodiments with reference to the attached drawings, in which:

FIG. 1 illustrates an environment in which an external intrusion detection function by a general secure boot module may operate;

FIGS. 2-5 are example diagrams for illustrating an operation of an external intrusion detection function by a general secure boot module;

FIG. 6 is an example diagram for illustrating a software update process by a general secure boot module;

FIGS. 7-9 are example flowcharts for illustrating a method for updating software by a secure boot module according to an embodiment of the present disclosure;

FIGS. 10-13 are example diagrams for illustrating a boot software update process according to an embodiment of the present disclosure; and

FIG. 14 illustrates an example computing device that may implement a device and/or system according to various embodiments of the present disclosure.

### DETAILED DESCRIPTIONS

Hereinafter, embodiments of the present disclosure are described with reference to the attached drawings. The advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that the present disclosure can be thorough and complete and can fully convey the concept of the present disclosure to those having ordinary skill in the art. The present disclosure should be only defined by the appended claims.

In adding reference numerals to the components of each drawing, it should be noted that the same reference numerals are assigned to the same or equivalent components as much as possible even though the components are shown in different drawings. In addition, in describing the present disclosure, when it is determined that the detailed description of the related well-known configuration or function may obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries are not ideally or excessively interpreted unless the terms are specifically defined otherwise. The terminology used herein is for the purpose of describing particular embodiments only and is not intended limit the present disclosure. In the present disclosure, the singular also includes the plural unless specifically stated otherwise in the phrase.

In addition, in describing the component of the present disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, and it should be also understood that another component also may be “connected,” “coupled” or “contacted” between each component. When a component, device, element, or the like of the present disclosure is described as having a purpose or performing an operation, function, or the like, the component, device, or element should be considered herein as being “configured to” meet that purpose or to perform that operation or function.

The terms “comprise”, “include”, “have”, etc. when used in the present, specify the presence of stated features, integers, steps, operations, elements, components, and/or combinations of them but do not preclude the presence or addition of one or more other features, integers, steps, operations, elements, components, and/or combinations thereof.

Hereinafter, an embodiment of the present disclosure are described in detail with reference to the accompanying drawings.

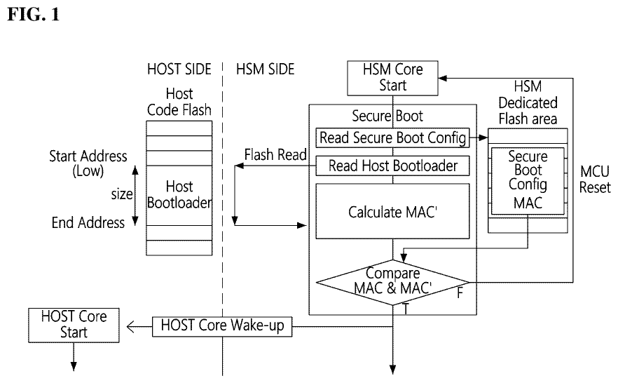

FIG. 1 illustrates an environment in which an external intrusion detection function by a general secure boot module may operate. Among the functions provided by a Hardware Security Module (HSM) as a module installed in the vehicle and providing security functions for an operation of a controller, a secure boot function, which has the strongest reaction, is a security function that identifies that a host bootloader of a host system has not been tampered with.

As shown in FIG. 1, when a wake-up signal for the host system occurs, the HSM wakes up prior to the host system and examines the host bootloader. The secure boot module stores a checksum MAC of the host bootloader instead of an original in the HSM dedicated flash area, compares MAC with MAC′ newly calculated from the host bootloader, and identifies whether the MAC and MAC′ are identical with each other.

The secure boot module allows operation of the host system when the MAC and MAC′ are identical with each other. However, when the MAC and MAC′ are not identical with each other, the secure boot module does not allow operation of the host system. The checksum is stored and used instead of the original because an operation of storing and comparing the original is inefficient for integrity check. Thus, the checksum may be collectively referred to as MAC. The secure boot module generates a reference checksum using a boot of a boot checksum check target. Upon detection that a boot checksum stored in a non-volatile memory of the secure boot module is different from the reference checksum, the secure boot module may recognize that the host bootloader has been tampered with and may stop the booting using an update target boot of the host system.

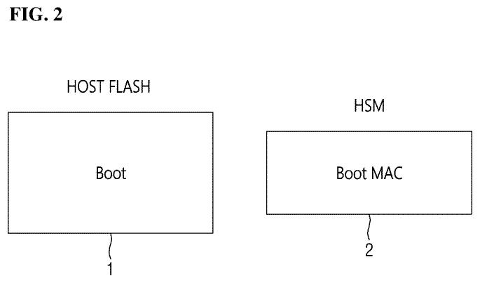

Simply diagrammatically, as shown in FIG. 2, when the reference checksum generated using the bootloader 1 included in a host code flash area and a boot MAC 2 corresponding to a boot checksum stored in the non-volatile memory of the secure boot module stored in the HSM are identical with each other, the host system booting may be performed.

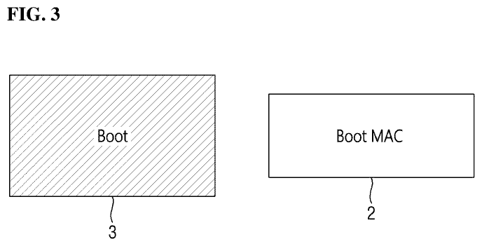

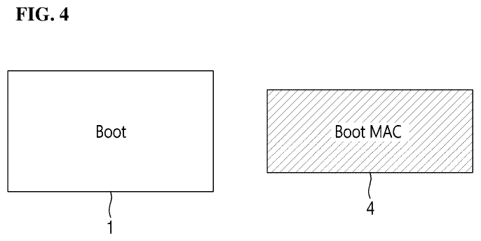

As shown in FIG. 3, when a bootloader 3 included in the host code flash area is tampered with such that the reference checksum generated using the bootloader 3 are not identical with the boot MAC 2 stored in the HSM corresponding to the boot checksum stored in the non-volatile memory of the secure boot module stored in the HSM. Alternatively, as shown in FIG. 4, when a boot MAC 4 stored in the HSM corresponding to the boot checksum stored in the non-volatile memory of the secure boot module stored in the HSM is tampered with and thus is not identical with the reference checksum generated using the bootloader 1 included in the host code flash area, the secure boot module determines that the boot integrity is damaged and does not perform booting. When the secure boot module determines that the boot integrity is damaged, the secure boot module will not operate forever.

Whether the bootloader included in the host code flash area has been tempered with is determined by the secure boot function (module) having the most powerful reaction among the functions provided by the HSM (Hardware Security Module). When the tampering is discovered, the secure boot module will not work forever. Thus, update is not usually required frequently, but the update thereof often occurs due to bugs being discovered.

When an update occurs on the boot included in the host code flash area as the boot area of the update target host, the boot MAC stored in the HSM should also be updated according to the change in the boot. However, in a situation where the bootloader included in the boot area of the update target host is being updated, the power may suddenly be cut off, and thus the software is caused to terminate abnormally, or an unexpected error may occur, and thus the update is caused to fail.

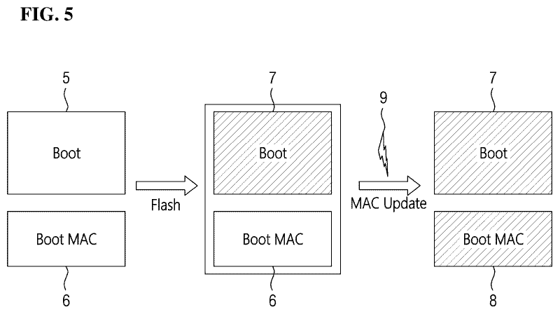

Alternatively, as shown in FIG. 5, an update occurs on a boot 5 existing in the boot area of the update target host. In this regard, in a situation where the boot 5 of the bootloader and a boot MAC 6 stored in the HSM generated using the boot 5 of the bootloader are updated, the existing boot of the bootloader is first deleted, a new boot is stored, and thus a boot 7 of the bootloader is updated. Then, the boot MAC 6 is updated to a new boot Boot MAC 8 using the boot 7 of the bootloader. During this process, the power may suddenly be cut off, and thus the software is caused to terminate abnormally, or an unexpected error 9 may occur, and thus the update is caused to fail. In that case, the boot MAC 8 stored in the HSM corresponding to the boot checksum stored in the non-volatile memory of the secure boot module stored in the HSM may be tampered with and thus may not be identical with the reference checksum generated using the boot 7 of the bootloader included in the host code flash area. Thus, the secure boot module in the HSM may determine that the integrity of the boot has been damaged.

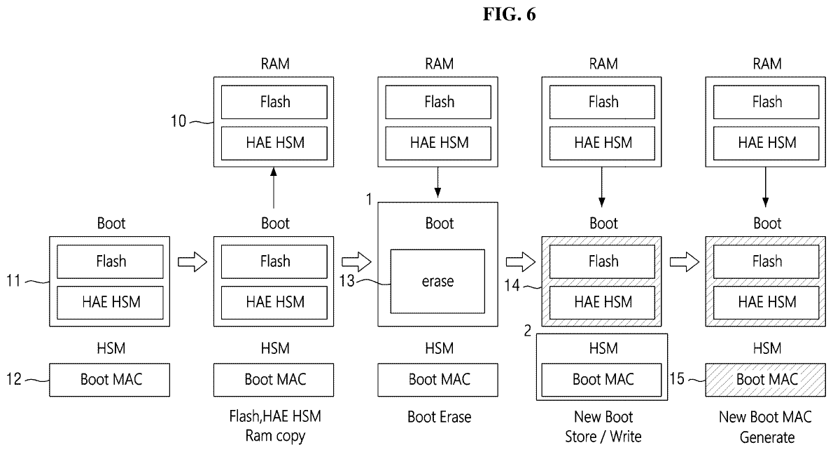

Referring to FIG. 6 as an example diagram for illustrating the software update process by a typical secure boot module, a situation in which HSM may determine that the integrity of the boot is damaged when an error occurs in the update situation is described. When updating the boot 11 of the update target host, first, the flash code that may perform erase of the existing boot and write of the new boot, and the HSM handler HAE HSM that may perform update of the boot MAC 12 are temporarily copied to RAM 10. Next, according to the flash code, the new boot is written to a boot 13 where the existing boot has been erased. When the new boot has been written to the boot, update of the boot MAC 15 is performed using a new boot 14 according to the HSM handler HAE HSM.

A situation in which the software is abnormally terminated or an unexpected error occurs due to a sudden power outage occurs in a situation BOX 1 where the existing boot has been erased. Then, when the secure boot module is activated, the secure boot module may identify that the MAC newly calculated using the erased host bootloader is identical with the existing boot MAC and may not allow operation of the host system.

Alternatively, a situation occurs in which the software is abnormally terminated or an unexpected error occurs due to a sudden power outage occur in a boot MAC update situation BOX 2. Then, when the secure boot module is activated, the secure boot module may identify that the MAC newly calculated using the host bootloader that wrote the new boot is not identical with the existing boot MAC and may not allow operation of the host system.

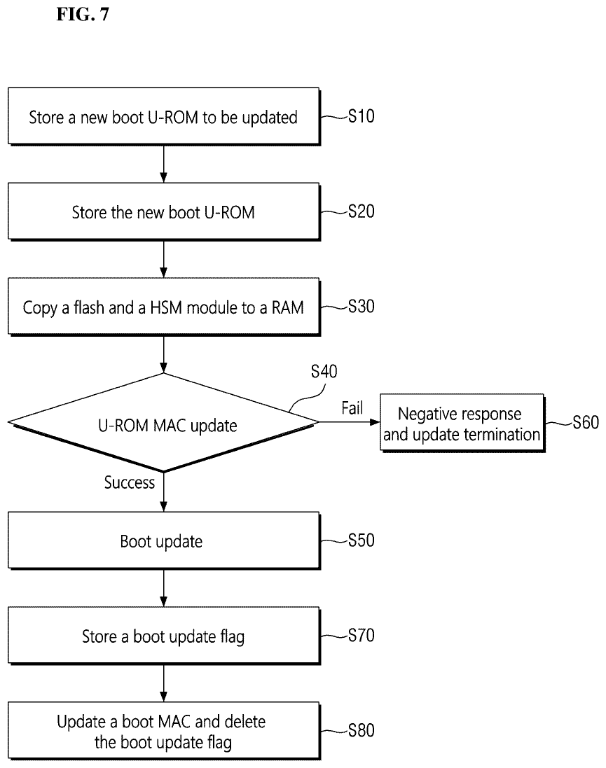

Therefore, a method is required to update the software by the secure boot module to prevent false detection so that the controller does not become incapable of recovery when the unexpected situation occurs in the middle of the update despite the secure boot module attempts to update the software in a normal manner. Hereinafter, an example sequence for updating the software by the secure boot module according to an embodiment of the present disclosure is described with reference to FIGS. 7-9.

First, as shown in FIG. 7, when the RAM resource is sufficient, the secure boot module may store a new boot U-ROM to be updated in operation S10. Next, the secure boot module may store the new boot U-ROM in the buffer area in operation S20.

Next, the secure boot module may copy the flash and the HSM module to the RAM in operation S30. Specifically, the secure boot module may temporarily copy the flash code that may perform erase of the existing boot of the update target host and write of the new boot, and the HSM handler HAE HSM that may perform update of the boot MAC to the RAM. After the secure boot module has stored the new boot in the buffer area, the secure boot module may set a boot checksum check target to the buffer area.

Next, the secure boot module may determine whether the secure boot module successfully performs U-ROM MAC update in operation S40. When the new boot has been written to the buffer, the secure boot module may perform boot MAC update using the new boot according to the HSM handler HAE HSM.

When the U-ROM MAC update fails in operation S40, the secure boot module may generate negative response in operation S60 and may terminate the update. When the U-ROM MAC update succeeds in operation S40, the secure boot module may perform the boot update in operation S50. The secure boot module may remove the existing boot of the update target host and may copy the new boot to the boot area of the update target host.

Next, the secure boot module may store a boot update flag in operation S70. When the secure boot module has performed the boot update flag storage, the secure boot module may set the boot checksum check target to the buffer area.

Next, the secure boot module may update the boot MAC, and may delete the boot update flag in operation S80. When the secure boot module has performed the boot update flag deletion, the secure bottom module may set the boot checksum check target to the boot area.

The secure boot module may generate the reference checksum using the boot of the boot checksum check target, may perform a reset operation of deleting the new boot stored in the buffer area, and may delete the boot update flag.

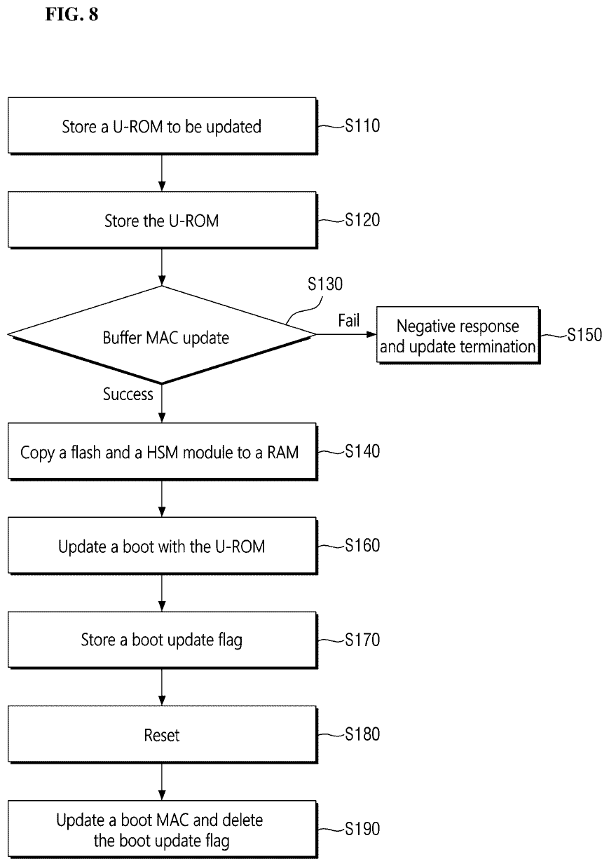

Next, as shown in FIG. 8, when RAM resource is insufficient, the secure boot module may store the new boot U-ROM to be updated in operation S110. The secure boot module may then store the new boot in the U-ROM buffer in operation S120. When the secure boot module has stored the new boot in the buffer area, the secure boot module may set the boot checksum check target to the buffer area.

Next, the secure boot module may determine whether the secure boot module successfully updates the buffer MAC using the checksum check target in operation S130. When the update fails, the secure boot module may generate a negative response in operation S150 and may terminate the update. Otherwise, when the update is successful, the secure boot module may copy the flash and the HSM module to the RAM in operation S140.

Next, the secure boot module may perform a boot update in operation S160. When the secure boot module has performed the boot update of the update target host, the secure boot module may store the boot update flag in operation S170.

When the secure boot module has stored the boot update flag, the secure boot module may perform a reset operation to delete the new boot stored in the buffer area in operation S180. When the secure boot module has performed the reset operation on the buffer area, the secure boot module may set the boot checksum check target to the boot area of the update target host.

Next, the secure boot module may perform the boot MAC update and the boot update flag deletion in operation S190. The secure boot module may generate the reference checksum using the boot of the boot checksum check target and may delete the boot update flag.

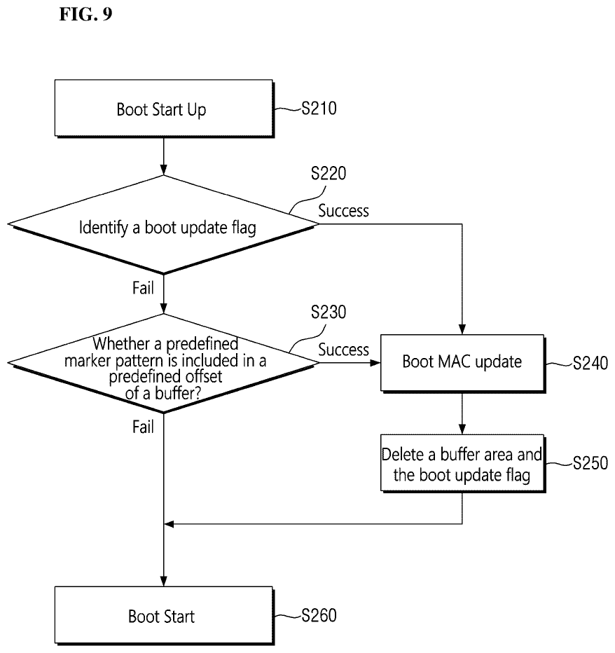

Next, the secure boot module may detect that an abnormal termination occurs during the software update, as shown in FIG. 9.

First, the secure boot module may start boot in operation S210 and may determine whether the secure boot module identifies the boot update flag in operation S220. When the boot update flag has been identified, the secure boot module may recognize that a new boot store is performed, may set the boot checksum check target to the boot area of the update target host, and may update the boot MAC in operation S240. The secure boot module may delete the buffer area and may delete the boot update flag in operation S250.

When the boot update flag is not identified, the secure boot module may determine whether a predefined marker pattern is included in a predefined offset of the buffer in S230. When the predefined marker pattern is included in the predefined offset of the buffer, there is a new boot stored in the buffer area. Thus, the secure boot module may detect that an abnormal termination occurs during the software update. Upon detection that the abnormal termination occurs, the secure boot module may set the checksum check target to the boot area of the update target host and may update the boot MAC in operation S240. The secure boot module may delete the buffer area and may delete the boot update flag in operation S250.

When the boot update flag is not identified and the predefined marker pattern is not included in the predefined offset of the buffer, the secure boot module may determine that the abnormal termination has not occurred and thus may perform the update or proceed with the booting in operation S260.

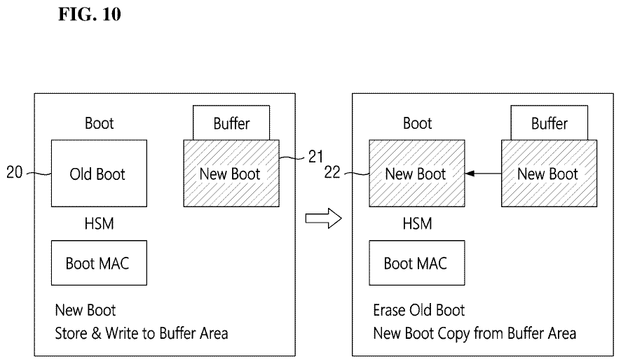

Next, the boot software update process according to an embodiment of the present disclosure is described with reference to FIGS. 10-13.

First, a method for minimizing an error in the software update process by the secure boot module is described with reference to FIG. 10. When the boot is updated by erasing the existing boot 20 of the update target host and storing a new boot, the erase, store, and write processes are partially repeated. The periods during which the erase, store, and write processes are partially in progress are all dangerous periods. Therefore, the present disclosure provides a method for minimizing the periods for which the erase, store, and write processes are in progress.

The present disclosure provides a method for using a portion of the RAM area where the storage is maintained when the power is turned off, rather than a temporary storage area, as a buffer area 21. In accordance with the present disclosure, the secure boot module stores and writes an entire new boot to the buffer area 21 while the existing boot remains in the boot area, and then the secure boot module performs only erase on the boot area 22 of the update target host and performs copy from the new boot of the buffer area 21 to the boot area 22 of the update target host. Thus, time may be shortened.

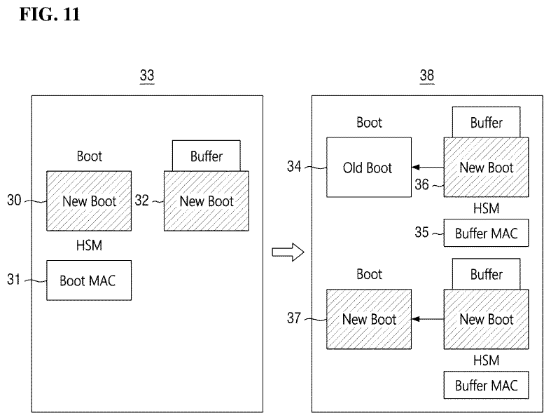

Next, referring to FIG. 11, the method to minimize the error in the software update process by the secure boot module is described. Not all problems are solved by the scheme using the buffer as described referring to FIG. 10. As in a scheme 33 using the buffer illustrated in FIG. 11, when the new boot of the buffer area 32 has been updated to the boot area 30 of the update target host, but the boot MAC 31 has not been updated, an entirety of a period until the boot MAC 31 has been updated becomes a dangerous period. Therefore, the present disclosure discloses a method for updating the boot MAC 31 prior to the boot area of the update target host.

The present disclosure provides a method for changing a target area targeted by the secure boot module to the buffer area 36 instead of the boot area 34 of the update target host before updating the new boot as in a scheme 38 of updating the boot MAC first before updating the new boot to the update target host. In accordance with the present disclosure, the secure boot module changes the target area to the buffer area 36 and performs an operation of updating the MAC value stored in the HSM into the buffer MAC 35.

Even when a rebooting occurs at this point when the MAC value stored in the HSM has become the buffer MAC and the target area targeted by the secure boot module has been changed to the buffer area 36, a relationship between the buffer area and the buffer MAC is maintained, so that the secure boot module may not determine that the boot integrity is damaged.

When the secure boot module has updated the MAC value stored in the HSM into the buffer MAC 35 using the new boot stored in the buffer area, the secure boot module performs an operation of updating the new boot into the boot area of the update target host. The new boot copied from the buffer area 36 is written to the boot area 37 of the update target host.

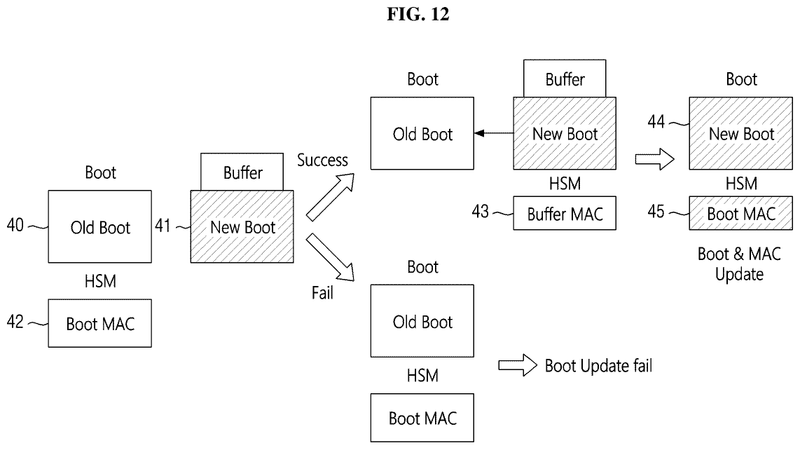

Next, referring to FIG. 12, a method for minimizing the error in the software update process by the secure boot module is minimized. When the boot area of the update target host is changed to delete the existing boot, but the MAC update fails, a situation where the MAC of the existing boot remains cannot be restored, and a time duration during which the situation is maintained becomes a dangerous period. The MAC update may occur when there is an error in the HSM handler or the boot electronic signature is invalid. Therefore, the present disclosure provides a method for designating the buffer area as the target area targeted by the secure boot module and generating the MAC.

The present disclosure provides a method for performing update of a MAC 42 using the new boot existing in a buffer area 41. In this way, the electronic signature failure situation may be prevented in advance, and the handler's operation may be identified to detect the error that may exist in the HSM handler. When the electronic signature failure situation does not occur and there is no problem with the handler's operation, it is expected that the secure boot module does will not fail to update, so that the operation of updating the new boot into the boot area 41 of the update target host may be performed. When the electronic signature failure situation occurs or there is a problem with the handler's operation, it is expected that the secure boot module fails to update, so that the update may be terminated.

When it is expected that the secure boot module does will not fail to update, the new boot may be updated into the boot area 41 of the update target host, and then the buffer MAC 43 may be updated into the boot MAC 45.

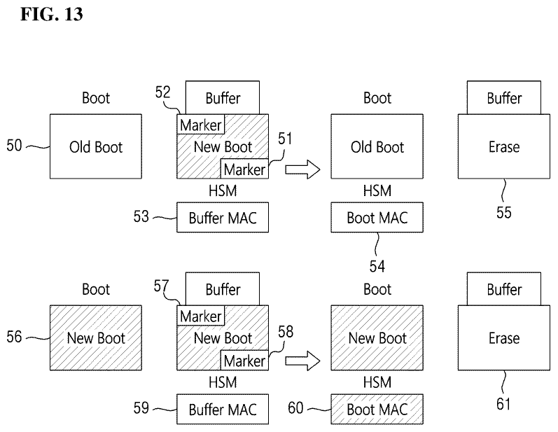

Next, referring to FIG. 13, a method for retrying the update upon recognizing that an event has occurred during the new boot update is described. When the buffer area is changed to the secure boot module target area, a situation in which the secure boot module determines that the boot integrity is damaged may be avoided. However, the buffer area may be modified for other reasons. Thus, when an abnormal termination situation occurs, it is necessary to detect this situation occurrence and restore the situation correctly.

An abnormal termination situation may occur before storing the new boot to the buffer area 51 and copying the new boot to the boot area 50 of the update target host. As the abnormal termination situation has occurred during the new boot update process, the reset on the buffer area 51 did not occur, and a marker 52, which may be used to determine that secure boot module update related software exists, may be a complex value such that the marker 52 cannot be located accidentally in the buffer area 51. The marker 52 in the buffer area 51 that may be used to determine that the secure boot module update related software exists may include a predefined marker pattern in a predefined offset.

As soon as the secure boot module identifies the marker 52 in the buffer area 51, the secure boot model sets the secure boot module target area to the boot area 50 of the update target host, sets the buffer area to the secure boot module target area, and updates a buffer MAC 53 updated using the boot of the buffer area into a boot MAC 54. The secure boot module does not determine whether a current time is after or before the boot area of the update target host is updated with the new boot, and deletes a buffer area 55, and the secure boot module updates the new boot into the boot area of the update target host again.

The abnormal termination situation may occur after copying the new boot to the buffer area 56 and before the buffer area 58 is reset. Because the abnormal termination situation has occurred during the new boot update process, the reset of the buffer area 58 did not occur, and a marker 57, which may be used to determine that secure boot module update related software exists, may be a complex value such that the marker 58 cannot be located accidentally in the buffer area 58. The marker 57 in the buffer area 58 that may be used to determine that the secure boot module update related software exists may include a predefined marker pattern in a predefined offset.

As soon as the secure boot module identifies the marker 57 in the buffer area 58, the secure boot model sets the secure boot module target area to a boot area 56 of the update target host, sets the buffer area to the secure boot module target area, and updates a buffer MAC 59 updated using the boot of the buffer area into a boot MAC 60. The secure boot module does not determine whether a current time is after or before the boot area of the update target host is updated with the new boot, deletes a buffer area 61, and updates the new boot into the boot area of the update target host again.

The method for updating the boot software according to an embodiment of the present disclosure has been described with reference to FIGS. 1-13. The methods according to the embodiments of the present disclosure described above may be performed by executing a computer program implemented using a computer-readable code. The computer program may be transmitted from a first computing device to a second computing device via a network such as the Internet and installed on the second computing device and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

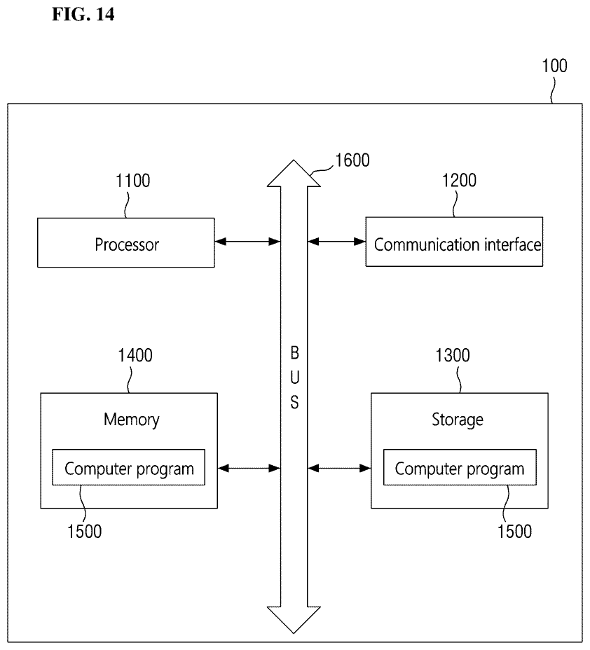

Hereinafter, with reference to FIG. 14, an example computing device 100 that may implement a boot software update device according to an embodiment of the present disclosure is described in more detail.

The computing device 100 may include one or more processors 1100, a bus 1600, a communication interface 1200, a memory 1400 that loads a computer program 1500 executed by the processor 1100 therein, and a storage 1300 that stores the computer program 1500 therein. However, only the components related to the embodiments of the present disclosure are depicted in FIG. 14. Accordingly, a person having ordinary skill in the art of the present disclosure should recognize that other general components may be included in addition to the components illustrated in FIG. 14.

The processor 1100 controls all operations of the components of the computing device 100. The processor 1510 may be configured to include at least one of a CPU (Central Processing Unit), an MPU (Micro Processor Unit), an MCU (Micro Controller Unit), a GPU (Graphics Processing Unit), or any further type of a processor well known in the technical field of the present disclosure. Furthermore, the processor 1100 may perform computations of at least one application or program for executing operations/methods according to an embodiment of the present disclosure. The computing device 100 may have one or more processors.

Next, the memory 1400 may store therein various data, commands, and/or information. The memory 1400 may load therein the computer program 1500 from the storage 1300 to execute operations/methods according to an embodiment of the present disclosure. The memory 1400 may be embodied as a volatile memory such as RAM. However, the present disclosure is not limited thereto.

Next, the bus 1600 may provide a communication function between the components of the computing device 100. The bus 1600 may be embodied as various types of buses such as an address bus, a data bus, and a control bus.

Next, the communication interface 1200 may support wired and wireless Internet communication of the computing device 100. Furthermore, the communication interface 1200 may support various communication schemes other than Internet communication. To this end, the communication interface 1200 may be configured to include a communication module well known in the technical field of the present disclosure.

According to an embodiment, the communication interface 1200 may be omitted.

Next, the storage 1300 may non-temporarily store therein one or more computer programs 1500 and various data.

The storage 1300 may be configured to include a non-volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the art to which the present disclosure belongs.

Next, the computer program 1500 may include one or more instructions that cause the processor 1100 to perform the operations/methods according to various embodiments of the present disclosure when the instructions are loaded into the memory 1400. In other words, the processor 1100 may execute one or more loaded instructions to perform the operations/methods according to various embodiments of the present disclosure.

In this way, an external intrusion detection device according to an embodiment of the present disclosure may be implemented using the computing device 100.

Although embodiments of the present disclosure have been described above with reference to the accompanying drawings, the present disclosure may not be limited to the embodiments and may be implemented in various different forms. Those having ordinary skill in the art to which the present disclosure belongs should appreciate that the present disclosure may be implemented in other specific forms without changing the technical idea or essential features of the present disclosure. Therefore, it should be understood that an embodiment as described above are not restrictive but illustrative in all respects.

Embodiments of the present disclosure have been described above with reference to FIGS. 1-14, but it should be noted that the effects of the present disclosure are not limited to those described above, and other effects of the present disclosure should be apparent from the present disclosure.

The technical features of the present disclosure described may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device. Thus, the computer program may be used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Those having ordinary skill in the art should appreciate that many variations and modifications can be made to the embodiments without substantially departing from the principles of the present disclosure. Therefore, the disclosed embodiments of the present disclosure are used in a generic and descriptive sense only and are not intended to limit the present disclosure.

What is claimed is:

1. A method for updating boot software, the method being performed by a computing device, the method comprising:
storing a new boot to a buffer area;
in response to success of the storing the new boot, removing an existing boot of an update target host;
copying the new boot to a boot area of the update target host; and
deleting the new boot stored in the buffer area.

2. The method of claim 1, further comprising:
generating a reference checksum using a boot of a boot checksum check target; and
when a boot checksum stored in a non-volatile memory of a secure boot module is different from the reference checksum, stopping a booting using a boot of the update target host.

3. The method of claim 2, wherein generating the reference checksum includes obtaining the boot checksum check target from secure boot module configuration data stored in the non-volatile memory of the secure boot module.

4. The method of claim 2, wherein removing the existing boot of the update target host in response to the success of the storing the new boot includes:
generating a boot checksum of the new boot using the new boot in response to the success of downloading;
updating a boot checksum stored in the non-volatile memory of the secure boot module;
setting the boot checksum check target to the buffer area; and
after completion of the setting, removing the existing boot of the update target host.

5. The method of claim 4, wherein the new boot includes a predefined marker pattern in a pre-specified offset,
wherein stopping the booting using the boot of the update target host when the boot checksum stored in the non-volatile memory of the secure boot module is different from the reference checksum includes:
performing a previous update success determination process when the boot checksum stored in the non-volatile memory of the secure boot module is identical with the reference checksum,
wherein the previous update success determination process includes:
identifying presence or absence of the predefined marker pattern in the pre-specified offset of the buffer area;
determining presence or absence of the new boot stored in the buffer area, based on an identifying result; and
upon determination that the new boot stored in the buffer area is present, retrying an update process using the new boot stored in the buffer area.

6. The method of claim 1, wherein copying the new boot to the boot area of the update target host includes storing a boot update flag.

7. The method of claim 1, further comprising, after deleting the new boot stored in the buffer area, setting a boot checksum check target to the boot area of the update target host.

8. The method of claim 7, wherein setting the boot checksum check target to the boot area of the update target host further includes deleting a boot update flag.

9. A computing system having a boot software update function, the computing system comprising:
a host including a boot area in which an existing boot is stored; and
a secure boot module including a random access memory (RAM),
wherein the secure boot module is configured to:
store a new boot for the host to a buffer area formed in the RAM;
remove an existing boot of the host from the boot area of the host in response to success of the storing the new boot;
copy the new boot stored in the buffer area to the boot area of the host; and
delete the new boot stored in the buffer area.

10. The computing system of claim 9, wherein the secure boot module is further configured to:
generate a reference checksum using a boot of a boot checksum check target; and
stop a booting using a boot of an update target host when a boot checksum stored in a non-volatile memory of the secure boot module and the reference checksum are different from each other.

11. The computing system of claim 10, wherein, when generating the reference checksum, the secure boot module is configured to obtain the boot checksum check target from secure boot module configuration data stored in the non-volatile memory of the secure boot module.

12. The computing system of claim 10, wherein, when removing the existing boot of the update target host in response to the success of the storing the new boot, the secure boot module is configured to:
generate a boot checksum of the new boot using the new boot in response to the success of the storing the new boot;
update a boot checksum stored in the non-volatile memory of the secure boot module;
set the boot checksum check target to the buffer area; and
remove the existing boot of the update target host after completion of the setting.

13. The computing system of claim 12, wherein the new boot includes a predefined marker pattern in a pre-specified offset,
wherein, when stopping the booting using the boot of the update target host when the boot checksum stored in the non-volatile memory of the secure boot module is different from the reference checksum, the secure boot module is configured to:
perform a previous update success determination process when the boot checksum stored in the non-volatile memory of the secure boot module is identical with the reference checksum,
wherein, when performing the previous update success determination process, the secure boot module is configured to:
identify presence or absence of the predefined marker pattern in the pre-specified offset of the buffer area;
determine presence or absence of the new boot stored in the buffer area, based on an identifying result; and
upon determination that the new boot stored in the buffer area is present, retry an update process using the new boot stored in the buffer area.

14. The computing system of claim 9, wherein, when copying the new boot to the boot area of an update target host, the secure boot module is configured to store a boot update flag.

15. The computing system of claim 9, wherein the secure boot module is further configured to set a boot checksum check target to the boot area of an update target host after deleting the new boot stored in the buffer area.

16. The computing system of claim 15, wherein, when setting the boot checksum check target to the boot area of the update target host, the secure boot module is configured to delete a boot update flag.
